(19) United States
(12) Patent Application Publication
(10) Pub. No.: US 2019/0346999 A1
(43) Pub. Date: Nov. 14, 2019

(54) METHOD AND DISPLAY DEVICE FOR DISPLAYING A USER INTERFACE FOR PRESENTING A CALENDAR

(71) Applicant: Qingdao Hisense Electronics Co., Ltd., Qingdao (CN)

(72) Inventors: Yanmei Yuan, Qingdao (CN); Youping FU, Qingdao (CN); Zhiqiang LI, Qingdao (CN)

(73) Assignee: Qingdao Hisense Electronics Co., Ltd, Qingdao (CN)

(21) Appl. No.: 16/443,598

(22) Filed: Jun. 17, 2019

Related U.S. Application Data
(63) Continuation of application No. PCT/CN2019/086067, filed on May 8, 2019.

(30) Foreign Application Priority Data
May 11, 2018 (CN) 201810447514.X

(51) Int. Cl. G06F 3/0484; G06Q 10/10

(52) U.S. Cl. CPC G06F 3/04847; G06Q 10/1093

(57) ABSTRACT

Methods and display devices are provided for displaying a user interface for presenting a calendar. The method includes displaying the user interface for presenting the calendar in response to a trigger instruction, wherein a plurality of dates arranged in line are presented in a first area of the user interface, and associated information associated with one of the plurality of dates is presented in a second area of the user interface, and presenting associated information associated with a first date in the second area, in response to the first date among the plurality of dates being selected through a remote controller.

This application is a continuation application of International Application No. PCT/CN2019/086067, filed on May 8, 2019, which claims priority to Chinese Patent Application No. 201810447514.X, filed on May 11, 2018, all of which are hereby incorporated by reference in their entirety herein.

### TECHNICAL FIELD

This disclosure relates to user interfaces on a terminal, and particularly to a method and display device for displaying a user interface for presenting a calendar on the terminal.

### BACKGROUND

A smart terminal (e.g., a smart TV set) is an electronic device configured with a variety of personalized demands for its users. For example, the smart TV set is based on the Internet application technology, working under an open operating system and using a chip, with an open application platform, and may interact with its users, providing audio-video, entertainment, data, and other functions to thereby bring a more convenient experience for users.

### SUMMARY

Embodiments of this disclosure provide a method and display device for displaying a user interface for presenting a calendar so as to display the calendar, and information associated with dates, and to allow a user to request conveniently and promptly for an operation related to the associated information.

In an embodiment of this disclosure, a method for displaying a user interface for presenting a calendar is provided. The method includes: displaying the user interface for presenting the calendar in response to a trigger instruction, wherein a plurality of dates arranged in line are presented in a first area of the user interface, and associated information associated with one of the plurality of dates is presented in a second area of the user interface; and in response to a first date among the plurality of dates being selected through a remote controller, presenting associated information associated with the first date in the second area.

According to some embodiments, the plurality of dates presented in the first area of the user interface are arranged in line in a first dimension; and the method further includes: in response to a direction button along a first preset direction on the remote controller being pressed, moving a focus frame from the first area where the first date is located to the second area in a second dimension; wherein the first preset direction is along the second dimension, and the second dimension is different from the first dimension.

According to some embodiments, the second area includes a first sub-area and a second sub-area, wherein local information associated with the first date is presented in the first sub-area, and at least one recommended item associated with the first date is presented in the second sub-area.

According to some embodiments, the first sub-area further includes at least one first visible control for setting the local information.

According to some embodiments, the method further includes: in response to an operation on a first visible control, presenting a setting interface for setting the local information; receiving information inputted in the setting interface; and associating the received information with the first date, and storing the received information.

According to some embodiments, the second sub-area includes at least one second visible control for presenting the at least one recommended item respectively.

According to some embodiments, the method further includes: in response to an operation on a second visible control, presenting details about a recommended item corresponding to the second visible control, or playing video content of a recommended item corresponding to the second visible control, or starting an application program of a recommended item corresponding to the second visible control.

According to some embodiments, the method further includes: in response to a direction button long a second preset direction on the remote controller being pressed, selecting a second date among the plurality of dates, wherein the second preset direction is along the first dimension; updating the second area to present associated information associated with the second date.

According to some embodiments, the method further includes: in response to the first date among the plurality of dates being selected by the remote controller, presenting an image corresponding to the first date as a background of the user interface.

In a second embodiment of this disclosure, an apparatus for displaying a user interface for presenting a calendar is provided, the device including: a user interface displaying module configured to receive a trigger instruction, and to display the user interface for presenting the calendar, where the user interface includes a date display area for displaying a plurality of dates arranged in line, and an associated information display area for displaying associated information related to one of the plurality of dates; a first responding module configured to receive a direction button instruction instructing a first dimension from a remote controller, to maintain a focus frame in position, to move the plurality of dates in the date display area in the first dimension, and to update the associated information display area to display associated information associated with a data in the focus frame; and a second responding module configured to receive a direction button instruction instructing a second dimension from the remote controller, and to move the focus frame between the date display area and the associated information display area.

In a third embodiment of this disclosure, a display device is provided, the display device including: a display screen, a memory, configured to store computer instructions and data associated with the display screen; and a processor in connection with the display screen and the memory and configured to execute the computer instructions to cause the display device to perform the method according to any one of the implementations in the first aspect above.

In a fourth embodiment of this disclosure, a computer readable nonvolatile storage medium storing thereon computer instructions configured to perform the method according to any one of the implementations in the first aspect above upon being executed on a processor is provided.

### BRIEF DESCRIPTION OF THE DRAWINGS

FIG. 1 illustrates a user interface for displaying associated information;

FIG. 2 illustrates a schematic diagram of a system architecture according to an embodiment of this disclosure;

FIG. 3a illustrates a schematic diagram of user interfaces according to embodiments of this disclosure respectively;

FIG. 3b illustrates a schematic diagram of user interfaces according to embodiments of this disclosure respectively;

FIG. 3c illustrates a schematic diagram of user interfaces according to embodiments of this disclosure respectively;

FIG. 3d illustrates a schematic diagram of user interfaces according to embodiments of this disclosure respectively;

FIG. 4 illustrates a schematic diagram of a user interface including two separate sub-areas in an associated information display area according to an embodiment of this disclosure;

FIG. 5 illustrates a schematic structural diagram of a user interface according to an embodiment of this disclosure;

FIG. 6a illustrates a user interface according to an embodiment of this disclosure;

FIG. 6b illustrates a user interface according to an embodiment of this disclosure;

FIG. 6c illustrates a user interface according to an embodiment of this disclosure;

FIG. 7a illustrates another user interface according to an embodiment of this disclosure;

FIG. 7b illustrates another user interface according to an embodiment of this disclosure;

FIG. 8 illustrates a schematic flow chart of a method for displaying a user interface for presenting a calendar according to an embodiment of this disclosure;

FIG. 9 illustrates a schematic flow chart of requesting for operating on associated information according to an embodiment of this disclosure;

FIG. 10 illustrates a schematic flow chart of requesting for setting associated information according to an embodiment of this disclosure;

FIG. 11 illustrates a schematic structural diagram of an apparatus for displaying a user interface for presenting a calendar according to an embodiment of this disclosure; and

FIG. 12 illustrates a schematic structural diagram of a display device according to an embodiment of this disclosure.

### DETAILED DESCRIPTION

Smart terminals are provided with various applications, and some of the applications present some type of data, and information associated with this type of data on a user Interface (UI). For example, a calendar is presented on a user interface, and when a user selects a date on the calendar by interacting with the terminal, some information associated with the date may be presented on the user interface. For example, the information associated with the selected date may include reminder information corresponding to the date, information about TV programs to be played on the date, etc., and the user may request for playing one or more TV programs, according to the information about TV programs to be played on the date.

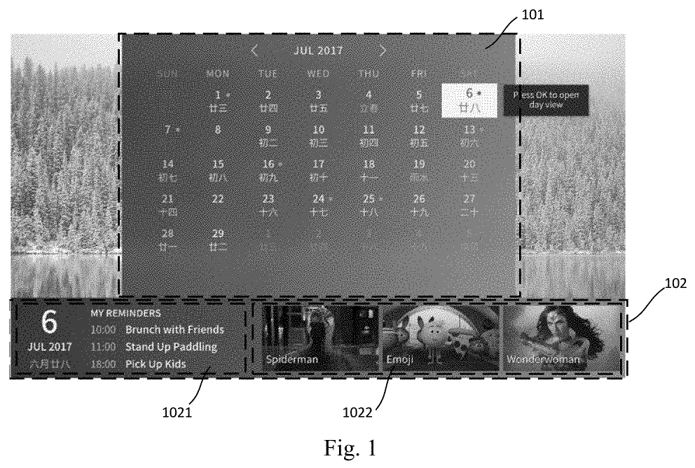

For example, FIG. 1 illustrates contents displayed in a user interface for presenting a calendar. The user interface may include a date display area 101 and associated information display area 102.

The date display area 101 is configured to display dates in a calendar, e.g., one of calendars from 1970 to 2049, and particularly weeks, solar calendar dates, lunar calendar dates, etc. The calendar is displayed in a conventional format, and for example, as illustrated in FIG. 1, dates of a month may be displayed in the date display area 101, where the dates of the month are displayed in multiple rows and columns, and dates of a week (from Monday to Sunday) are displayed in each row in order.

Information presented in the associated information display area 102 is associated with the currently selected date in the date display area 101. The associated information display area 102 may further include two sub-areas, i.e., a reminder information display area 1021 and a recommended item display area 1022, where reminder information associated with the currently selected date, e.g., memo information, a schedule, etc., may be displayed in the reminder information display area 1021, and recommended items associated with the currently selected date, e.g., information about a TV program, information about a movie, etc., may be displayed in the recommended item display area 1022. The recommended item display area 1022 may include one or more sub-areas where each recommended item is displayed individually.

As illustrated in FIG. 1, for example, upon selecting Jul. 6, 2017 in the date display area 101, in response to the selection, reminder information associated with the date is displayed in the reminder information display area 1021, where schedule information on the day is displayed in the area as illustrated in FIG. 1; and recommended items associated with the date are displayed in the recommended item display area 1022, where pictures of three movie programs recommended to the user for watching are displayed in the area as illustrated in FIG. 1, and the three movie programs are the movie Spiderman, the cartoon Emoji, and the movie Wonderwomen respectively.

For the currently selected Jul. 6, 2017, the user cannot select directly the movie Spiderman presented in the recommended item display area 1022 for playing, because in order to select the movie Spiderman presented in the recommended item display area 1022, the user needs to operate on the Up and Down direction buttons on a remote controller to thereby move a focus upward and downward, but the focus will not land on the picture of the movie Spiderman until it passes other dates, e.g., July 13, July 20, and July 27, while being moved downward. As the focus is moving to the other dates, the item displayed in the recommended item display area 1022 varies with the different dates where the current focus lands.

In a scheme, the problem above may be addressed by introducing more user operations. For example, when Jul. 6, 2017 is selected (that is, the current focus lands on Jul. 6, 2017), the user presses some button (e.g., the Menu button) on the remote controller to lock on the date, and then moves the focus downward to the picture of the movie Spiderman in the recommended item display area 1022 through the remote controller. Since Jul. 6, 2017 has been locked on, the items displayed in the recommended item display area 1022 are still the recommended items associated with locked-on Jul. 6, 2017 although the focus is moved to the other dates.

Although information associated with each other may be displayed, and a related operation may be performed on associated information in the above scheme, additional user operations shall be introduced, thus increasing the complexity, and degrading the user experience.

The embodiments of this disclosure provide a method and device for displaying a user interface for presenting a calendar so as to display the calendar, and information associated with a date, and to allow a user to request conveniently and promptly for the associated information.

This disclosure will be described below in details with reference to the drawings.

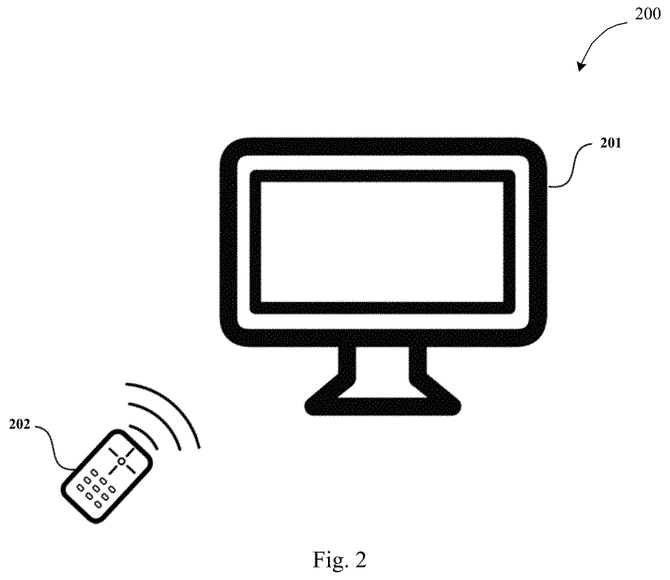

FIG. 2 illustrates a system architecture to which this disclosure is applicable.

As illustrated in FIG. 2, the system architecture 200 includes a terminal 201 and a remote controller 202, where the remote controller 202 may send a control instruction to the terminal 201 in a wireless or wired manner.

For example, information is exchanged between the remote controller 202 and the terminal 201 through radio communication, where the remote controller 202 is a radio transmitter, and the user may interact with the terminal 201 by operating on the remote controller 202 in a human-machine interaction manner. In an scenario, the remote controller 202 digitally encodes information about a button pressed by the user, and transmits a light wave through an infrared diode, and the light wave is received by an infrared receiver of the terminal 201, so the infrared receiver converts received infrared signal into an electric signal, and then a processor decodes it into the corresponding instruction, and executes the instruction for controlling the terminal 201 to perform a desired operation.

By way of example, the terminal 201 is a smart TV set, and the remote controller 202 is a remote controller of the smart TV set. According to some embodiments, the system architecture 200 may further include a set-top box (not illustrated) connected with the smart TV set. The set-top box, also referred to as a digital video conversion box, is configured to convert a compressed digital signal into a TV program, and to display the TV program on the smart TV set. The set-top box may be built in the smart TV set, or may be attached to the smart TV set. The control instruction sent by the remote controller is received and decoded by the set-top box, and then the decoded control instruction is sent to the smart TV set.

The remote controller above may be replaced with another control device with a similar function, e.g., a mobile user equipment. The mobile user equipment may be connected with the smart TV set by setting up wireless communication therewith, and send the control instruction to the smart terminal over the wireless communication connection. The mobile user equipment may be a smartphone, a tablet computer, a Personal Digital Assistant (PDA), a smart wearable device, etc.

Based upon the system architecture 200, in the embodiments of this description, the user may interact with the terminal 201 through the remote controller 202, and the terminal 201 may display information associated with each other in the user interface, and allow the user to request for associated information by convenient operations.

In the embodiments of this description, the user interface for displaying the information associated with each other includes an object display area and an associated information display area; and for the sake of description, the object display area is referred to as a first area, and the associated information display area is referred to as a second area. The object display area is configured to display N objects (N is an integer more than or equal to 1) arranged in one dimension, and while a focus is being switched among the N objects arranged in one dimension, the focus is switched among the N objects in a dimension. After the focus lands on one of the N objects, associated information associated with the object where the focus currently lands is displayed in the associated information display area.

Particularly the “objects” presented in the object display area of the user interface above may be time related objects (e.g., dates), place related objects (e.g., cities), etc., although the embodiments of this description will not be limited thereto. For example, the user interface is configured to display a calendar, so the “objects” in the object display area of the user interface are dates in the calendar, and in this case, the object display area in the user interface configured to display a calendar is referred to as a “date display area”.

The “associated information” presented in the associated information display area of the user interface above may include a number of types of information. In the example where the object display area is configured to display a calendar, for example, the associated information display area is configured to display reminder information and/or recommended items associated with a selected date, where the recommended items may include a movie program recommended for watching, an application recommended for use, etc. Associated information associated with different objects may or may not be the same.

In the embodiments of this description, the objects are “arranged in one dimension” as opposed to “arranged in a plurality of dimensions”. In the example where the objects are arranged in one dimension, for example, the N objects are arranged in one row or in one column, that is, the N objects arranged in one row or in one column are presented in the first area; and in an example where the objects are arranged in a plurality of dimensions, the N objects are arranged in multiple rows and columns, and for example, dates are displayed in the date display area 101 as illustrated in FIG. 1.

For example, when N dates are arranged in one dimension in the date display area of the user interface configured to display a calendar, a focus may only be switched among the N dates through direction buttons along a first dimension on the remote controller. Furthermore upon selecting a date, the focus may be switched to associated information which is associated with the currently selected date and presented in the associated information display area, through direction buttons long a second dimension on the remote controller, where the first dimension and the second dimension is one and the other of the horizontal dimension and the vertical dimension respectively.

In the case that the N dates are arranged in one row, for example, the user may only control the focus to be switched among the N dates, through horizontal movement direction buttons (e.g., the Left and Right direction buttons) on the remote controller, and after a date is selected, the user may switch the focus to associated information which is associated with the currently selected date and presented in the associated information display area through vertical movement direction buttons (e.g., the Up and Down direction buttons) on the remote controller.

In another example, in the N dates are arranged in one column, for example, the user may only control the focus to be switched among the N dates, through the vertical movement direction buttons on the remote controller, and after a date is selected, the user may switch the focus to associated information which is associated with the currently selected date and presented in the associated information display area through the horizontal movement direction buttons on the remote controller, where the Left and Right direction buttons on the remote controller are control buttons representing the same dimension (the horizontal movement direction), and the Up and Down direction buttons on the remote controller are control buttons representing the same dimension (the vertical movement direction).

In the embodiments of this description, the N objects may be arranged in the following one-dimension pattern:

In a first arrangement pattern, the N objects are arranged horizontally.

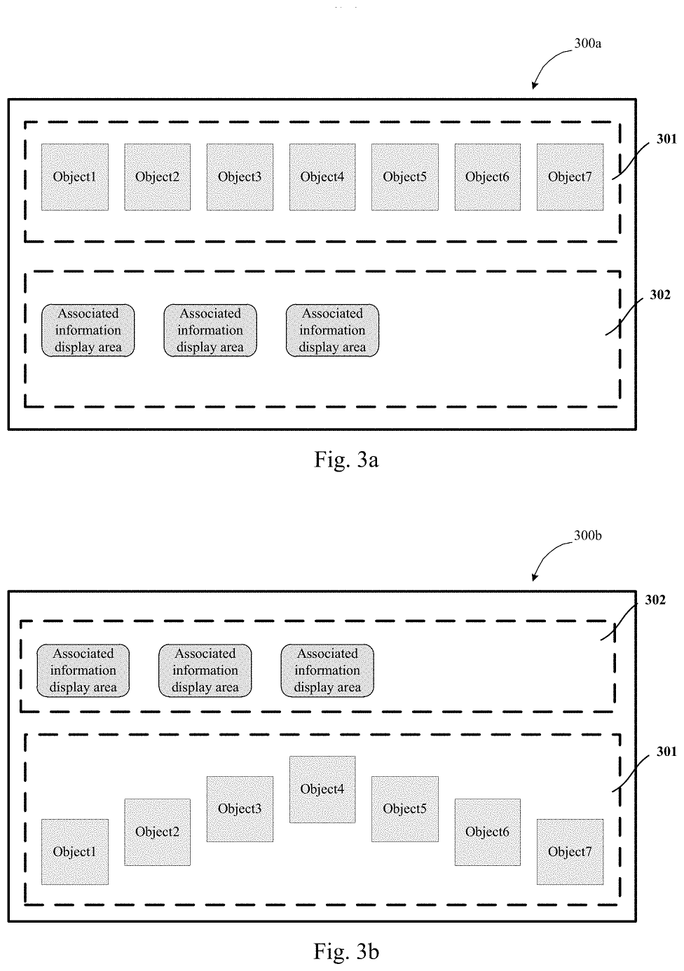

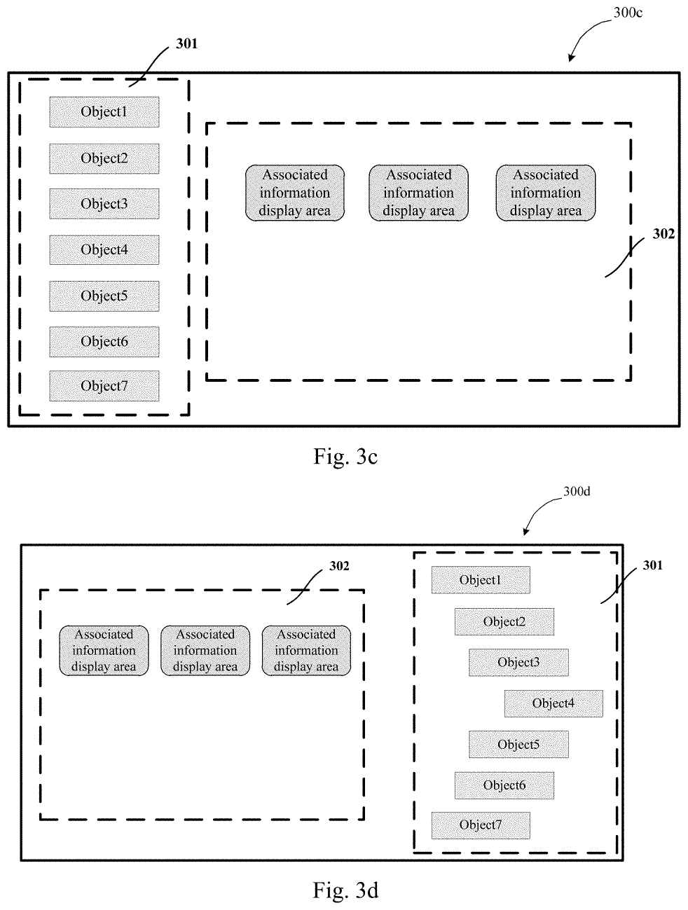

Particularly the arrangement in the horizontal direction may include horizontally linear arrangement (for example, the N objects are arranged in one row) as illustrated in FIG. 3a. N (7 as illustrated) objects are arranged in one row in an object display area (i.e., a first area) 301 of a user interface 300a. An associated information display area (i.e., a second area) is arranged above or below the object display area. FIG. 3a illustrates the associated information display area 302 below the object display area 301 by way of example. In the user interface as illustrated in FIG. 3a, the user may switch a focus among the N objects through the Left and Right direction buttons on the remote controller, and after a date is selected, the user may switch the focus to associated information which is associated with the object and presented in the associated information display area 302 through the Down direction button on the remote controller.

The arrangement in the horizontal direction may alternatively include horizontal curved arrangement (for example, the N objects are arranged in an arc extending in substantially the horizontal direction) as illustrated in FIG. 3b. N (7 as illustrated) objects are arranged in an arc extending in the horizontal direction in the object display area (i.e., a first area) 301 of a user interface 300b. An associated information display area (i.e., a second area) may be arranged above or below the object display area. FIG. 3b illustrates the associated information display area 302 below the object display area 301 by way of example. In the user interface as illustrated in FIG. 3b, the user may switch a focus among the N objects through the Left and Right direction buttons on the remote controller, and after a date is selected, the user may switch the focus to associated information which is associated with the object and presented in the associated information display area 302 through the Up direction button on the remote controller.

In a second arrangement pattern, the N objects are arranged vertically.

Particularly the arrangement in the vertical direction may include vertically linear arrangement (for example, the N objects are arranged in one column) as illustrated in FIG. 3c. N (7 as illustrated) objects are arranged in one column in an object display area (i.e., a first area) 301 of a user interface 300c. An associated information display area (i.e., a second area) may be arranged on the left or right to the object display area. FIG. 3c illustrates the associated information display area 302 on the right to the object display area 301 by way of example. In the user interface as illustrated in FIG. 3c, the user may switch a focus among the N objects through the Up and Down direction buttons on the remote controller, and after a date is selected, the user may switch the focus to associated information which is associated with the object and presented in the associated information display area 302 through the Right direction button on the remote controller.

Particularly the arrangement in the vertical direction may alternatively include vertical curved arrangement (for example, the N objects are arranged in an arc extending in substantially the vertical direction) as illustrated in FIG. 3d. N (7 as illustrated) objects are arranged in an arc extending in the vertical direction in an object display area (i.e., a first area) 301 of a user interface 300d. An associated information display area (i.e., a second area) may be arranged on the left or right to the object display area. FIG. 3d illustrates the associated information display area 302 on the left to the object display area 301 by way of example. In the user interface as illustrated in FIG. 3c, the user may switch a focus among the N objects through the Up and Down direction buttons on the remote controller, and after a date is selected, the user may switch the focus to associated information which is associated with the object and presented in the associated information display area 302 through the left direction button on the remote controller.

In a third arrangement pattern, the N objects are arranged diagonally.

Particularly the diagonal arrangement may include diagonally linear arrangement (for example, the N objects are arranged diagonally and linearly in the user interface). For example, the N objects are arranged diagonally and linearly in the object display area (i.e., the first area) of the user interface. The associated information display area (i.e., the second area) may be arranged on the left or right to the object display area. The associated information display area is on the right to the object display area, for example, and the user may switch the focus among the N objects through the Up and Down direction buttons on the remote controller, and after a date is selected, the user may switch the focus to associated information which is associated with the object and presented in the associated information display area through the Right direction button on the remote controller.

The diagonal arrangement may alternatively include diagonally curved arrangement (for example, the N objects are arranged diagonally in the user interface in a curved pattern). For example, the N objects are arranged diagonally in the object display area (i.e., the first area) of the user interface in a curved pattern. The associated information display area (i.e., the second area) may be arranged on the left or right to the object display area. The associated information display area is on the right to the object display area, for example, and the user may switch the focus among the N objects through the Up and Down direction buttons on the remote controller, and after a date is selected, the user may switch the focus to associated information which is associated with the object and presented in the associated information display area through the Right direction button on the remote controller.

Several typical arrangement patterns in one dimension have been described above only by way of example, but the embodiments of this description will not be limited thereto, and for example, the N objects in the object display area may be arranged asymmetrically as long as the focus may only be switched among the N objects through control buttons representing the same dimension on the remote controller, and after an object is elected, the focus may be switched to associated information which is associated with the object and presented in the associated information control region through control buttons representing the other dimension.

According to some embodiments, the associated information display area (i.e., the second area) may include a plurality of sub-areas, e.g., a first sub-area and a second sub-area, where local information associated with a selected object is presented in the first sub-area, and at least one recommended item associated with the selected object is presented in the second sub-area.

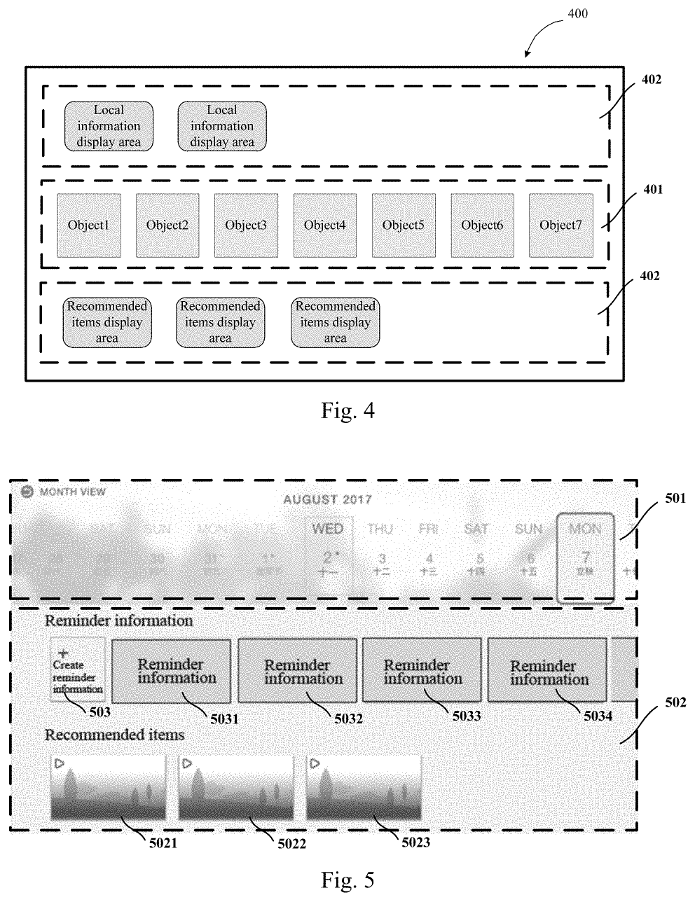

In the examples above, the associated information display area (i.e., the second area) in the user interface is a consecutive area, but in another example, the associated information display area in the user interface may alternatively include a plurality of discrete sub-areas. As illustrated in FIG. 4, for example, N objects are arranged in one row in an object display area 401 of a user interface 400. An associated information display area 402 includes two sub-areas located respectively above and below the object display area 401, and for the sake of description, the two sub-areas is referred to as a first sub-area and a second sub-area respectively, where the first sub-area above the object display area is configured to display local information associated with a selected object, e.g., reminder information, and the second sub-area located below the object display area is configured to display one or more recommended items associated with the selected object. In the user interface as illustrated in FIG. 4, the user may switch a focus among the N objects through the Left and Right direction buttons on the remote controller, and after an object is selected, the user may switch the focus to local information which is associated with the object and presented in a sub-area of the associated information display area 402 above the object display area 401, through the Up direction button; or after an object is selected, the user may switch the focus to a recommended item which is associated with the object and presented in another sub-area of the associated information display area 402 below the object display area 401, through the Down direction button.

As may be apparent from the description above, in the embodiments of this description, the N objects are arranged in one dimension so that the focus may only be moved in one dimension while being switched among the N objects, and in this way, while the focus landing on an object is being moved in another direction dimension, the focus may land on associated information which is associated with the object and presented in the associated information display area, instead of landing on any other object among the N objects. As illustrated in FIG. 3a, for example, in the case that the object display area is a date display area, a plurality of dates displayed in the date display area are arranged in one row, and the different dates may only be selected through the Left or Right button on the remote controller; and after a date is selected, a recommended item associated with the date instead of another date may be selected through the Down direction button on the remote controller, so that the user may select associated information associated with the date conveniently and promptly without any additional operation or special guiding reminder to thereby perform a related operation on the associated information.

According to some embodiments, in some embodiments of this description, the associated information displayed in the associated information display area of the user interface may include a variety of types of information. For example, associated information associated with a date may include at least one of the following items: local information, e.g., reminder information (e.g., a memo, a schedule, a working plane, etc.), recommended items (e.g., videos recommended for watching, application recommended for use, products recommended for purchasing, etc.)

The associated information displayed in the associated information display area of the user interface may be rendered in a variety of forms. For example, the associated information above may be information which is only displayed, but may not be operated on, e.g., reminder information, or may be information which may be operated on, e.g., a video recommended for watching.

The associated information which may be operated on may be displayed in the associated information display area as a visible control which may be displayed as a picture, a text, or another type of media information related to the associated information, and after the visible control is triggered, a corresponding operation may be performed on the related associated information. For example, the associated information is a video recommended for watching, and a related picture of the video recommended for watching (e.g., a thumbnail of a movie poster) may be arranged in the associated information display area in the user interface as a visible control, and the visible control is associated with a Uniform Resource Identifier (URI) of the video recommended for watching; and after the control is triggered, a video player may be started, and the corresponding video may be played according to the URI associated with the visible control.

The number of associated information displayed in the associated information display area of the user interface may be one or more. For example, the associated information display area may include one or more sub-areas, each of which is configured to display one piece of associated information.

The associated information is displayed in the associated information display area of the user interface. In terms of sources, it is provided by a system (that is, the associated information is set by the system), or by the user (that is, the associated information is set by the user). For example, the associated information associated with a date may include reminder information and a recommended item, where the reminder information is set by the user, and the recommended item is set by the system.

In order for the user to set the associated information conveniently, in some embodiments of this disclosure, the associated information display area of the user interface may further include a visible control configured to provide a function of setting the associated information. The control may be displayed as reminder information to instruct the user to trigger the control to create the associated information. After the user triggers the control, an associated information setting interface is opened, and the associated information may be set in the interface. In the embodiments of this description, in order to set the associated information, the user is allowed to select an object so that the currently set associated information is associated with the selected object. The currently set associated information is associated with the currently selected object by default. Furthermore in the case that the associated information is set and associated with the currently selected date, the currently set associated information may be displayed in the associated information display area of the user interface.

According to some embodiments, in the embodiments of this description, the focus may be switched among the different objects in the object display area through first dimension buttons on the remote controller in the following two implementations:

(1) a first switch implementation:

The position of a focus frame is maintained, and the objects are controlled to be moved in the first dimension through the direction buttons along the first dimension on the remote controller, so that the focus is switched among the different objects.

Particularly after the terminal receives a instruction sent by the direction button of the remote controller to move in a first dimension, the current position of the focus frame is maintained in response, and all the objects in the object display area are moved respectively by one place in a second direction so that a first object is moved out of the focus frame, and a second object adjacent to the first object in the first dimension is moved into the focus frame, where the first dimension is opposite to the second direction. As the object in the focus frame is updated, the associated information display area is updated to display associated information related to the object in the focus frame.

Here the first dimension may be the horizontal direction, and the direction buttons representing the horizontal direction may include the Left and Right direction buttons; or the first dimension may be the vertical direction, and the direction buttons representing the vertical direction may include the Up and Down direction buttons.

For example, the focus is switched among the different objects through the Left and Right direction buttons on the remote controller, and the terminal receives a direction button instruction instructing the left-right direction from the remote controller, so the focus frame in the object display area is maintained in position, and the objects are moved in the left-right direction along the horizontal direction.

Particularly in an interaction design of the user interface, the currently selected object where the focus lands may be indicated in the focus frame. The focus frame may be moved in a corresponding direction in response to the direction button instruction of the remote controller. The focus frame is showed as a background picture, or a frame in a preset color, or an area filled in a preset color, although the embodiments of this description will not be limited thereto.

For example, an object in the focus frame in the current object display area is a first object, and an object right-adjacent to the first object is a second object. Upon reception of an instruction from the Right direction button of the remote controller, the current position of the focus frame in the object display area is maintained in response, and all the objects in the object display area are moved leftward by one place, so that the first object is moved out of the focus frame, and the second object right-adjacent to the first object is moved into the focus frame.

In another example, an object in the focus frame in the current object display area is a first object, and an object left-adjacent to the first object is a second object. Upon reception of an instruction from the Left direction button of the remote controller, the current position of the focus frame in the object display area is maintained in response, and all the objects in the object display area are moved rightward by one position, so that the first object is moved out of the focus frame, and the second object left-adjacent to the first object is moved into the focus frame.

In the user interface illustrated in FIG. 3a, when the focus is located in the display area, the focus frame may be fixed in the display area of the fourth object. In the case that the current object in the focus frame is “Object 4”, upon reception of an instruction from the Right direction button of the remote controller, the focus frame is still located in the original area in response, but the object in the focus frame is Object 5, that is, Object 1 to Object 7 are moved leftward respectively by one position, so that Object 4 is moved to the left side to the focus frame, and Object 5 is moved into the focus frame. The objects presented in the object display area are changed from Object 1 to Object 7 as illustrated in FIG. 3a to Object 2 to Object 8, where the focus frame is still located in the display area of the fourth object.

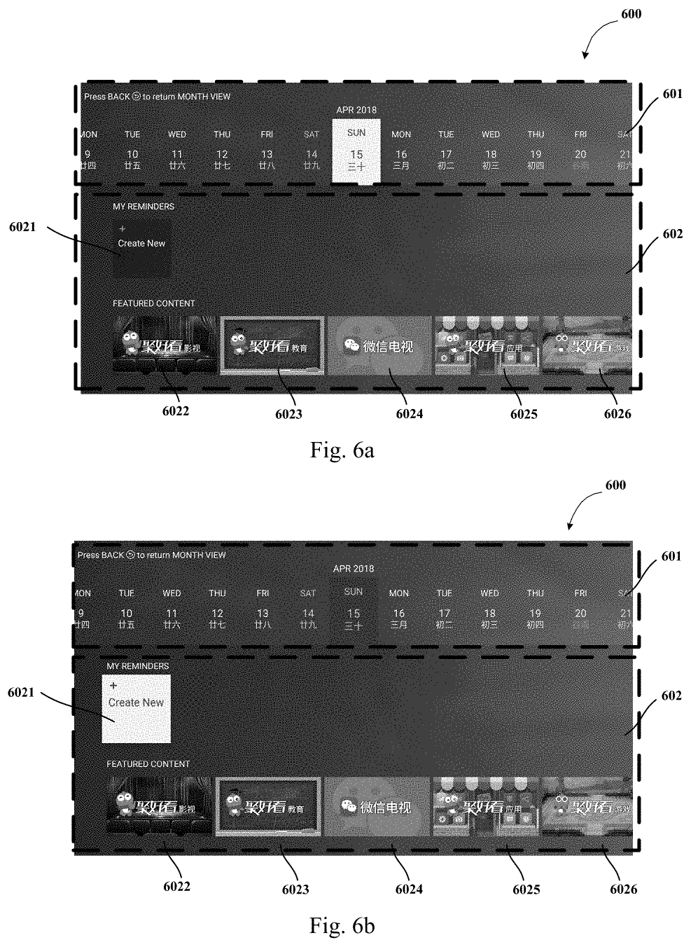

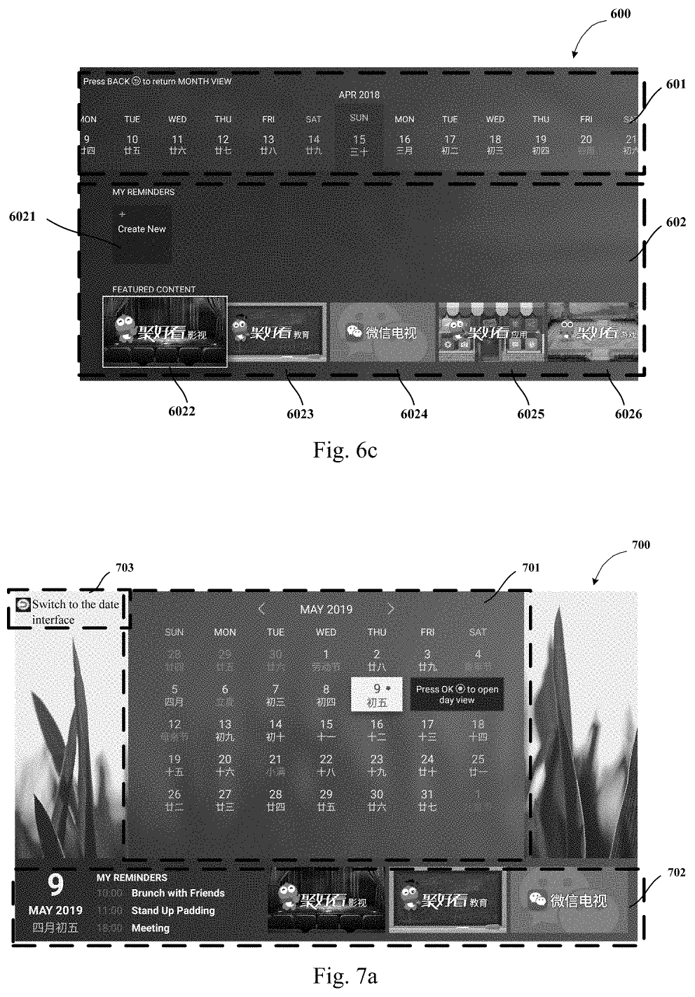

In some examples, in a calendar application, for example, a calendar displayed in the date display area may be a parent control, and each date in the calendar may be a child control. As illustrated in FIG. 6a, the focus currently lands on the child control corresponding to April 15, and upon reception of an instruction from the Right direction button of the remote controller, the current position of the focus frame is maintained, the next child control corresponding to April 16 to be moved into the focus frame (i.e., the next child control where the focus is to land) is determined, the number of places by which the child control is to be moved leftward is calculated as one, and the parent control is further controlled to be moved leftward by one place, so that the focus lands on the child control corresponding to April 16.

(2) a second switch implementation:

The position of the focus frame is controlled to be moved in the first dimension through the direction buttons representing the first dimension on the remote controller, so that the focus is switched among the different objects.

For example, the focus is switched among the different objects through the Left and Right direction buttons on the remote controller, and the terminal receives an instruction from the left-right direction of the remote controller, so that the focus frame in the object display area is moved in the left-right direction. As the focus frame is moved, the associated information display area is updated to display associated information related to the object in the focus frame.

For example, dates from January 1 to January 7 are displayed in the current date display area, the date in the current focus frame is January 2, the date right-adjacent to January 2 is January 3, and the date left-adjacent to January 2 is January 1. Upon reception of an instruction from the Right direction button of the remote controller, the focus frame in the date display area is moved rightward by one position in response, so that the focus frame is moved to the position of January 3; or upon reception of an instruction from the Left direction button of the remote controller, the focus frame in the date display area is moved leftward by one place in response, so that the focus frame is moved to the position of January 1.

Furthermore when the focus frame is moved to the right edge of the date display area, the next page of dates or the next date may be displayed; and when the focus frame is moved to the left edge of the date display area, the last page of dates or the last date may be displayed.

In the user interface as illustrated in FIG. 3a, for example, the current focus frame is located in the area of Object 4, and upon reception of an instruction from the Right direction button of the remote controller, the focus frame is moved rightward by one place in response, that is, the focus frame is moved to the area of Object 5, and the positions of the respective objects are maintained. After the focus frame is moved to the position of Object 7, if a instruction from the Right direction button of the remote controller is received again, the next page of dates or the next date may be displayed, and the focus frame may be moved into the area of the object right-adjacent to Object 7.

In some examples, in a calendar application, for example, a calendar displayed in the date display area may be a parent control, and each date in the calendar may be a child control. As illustrated in FIG. 6a, the focus currently lands on the child control corresponding to April 15, and upon reception of an instruction from the Right direction button of the remote controller, the next child control corresponding to April 16 where the focus is to land is determined, so the focus frame is moved to the child control corresponding to April 16, and the focus lands on the child control corresponding to April 16.

Furthermore after the focus frame is moved to the child control corresponding to April 20, upon reception of an instruction from the Right direction button of the remote controller, the next child control corresponding to April 21 where the focus is to land is determined (the child control corresponding to April 21 is located in invisible areas, and the child controls corresponding to the dates between April 9 and 20 are located in a visible area), the number of places by which the focus frame is to be moved rightward is calculated as one, and then the current position of the focus frame is maintained, and the parent control is controlled to be moved leftward by one place, so that the focus lands on the child control corresponding to April 21; or the parent control is controlled to be moved leftward by the length of one visible area (12 places), and the focus frame is controlled to be moved leftward by 11 places, so that the focus lands on child control corresponding to April 21, that is, the next page of dates are displayed.

According to some embodiments, in some embodiments of this disclosure, in response to the focus landing on one of the N objects (e.g., dates in a calendar application), the object where the focus currently lands is identified in the focus frame in the user interface to be distinguished from the other objects not in focus frame. For example, the object where the focus currently lands may be highlighted by setting a display mode of the focus frame. In a calendar application, for example, the date in the focus frame may be highlighted in one or more of the following ways.
1. A display color of the date in the focus frame is set to display in a distinguished color so that the display color of the date where the focus lands is different from that of the objects not in focus. For example, the date where the focus currently lands may be displayed in a highlighted color.
2. A display manner of the date in the focus frame is set to displayed in a distinguished way so that the display manner of the date where the focus lands is different from that of the objects not in focus frame. For example, the date where the focus currently lands may be displayed clearly, and the objects not in focus frame may be displayed faintly;
3. A display size of the date in the focus frame is set to present in a another size so that the display size of the date where the focus lands is different from that of the objects not in focus. For example, the date where the focus currently lands may be displayed in a larger size.
4. A background of the focus frame is set to present a distinguished background so that the background of the date where the focus lands is different from backgrounds of the objects not in focus.

The object where the focus currently lands may be highlighted as described above only. In other embodiments, the focused object may be distinguished in other manners.

According to some embodiments, when the focus lands on one of the N objects (referred below to as a first object for the sake of description) (that is, the focus frame is located in the area of the object), if the focus is switched into the associated information display area (that is, the focus frame is moved into the associated information display area), for example, to associated information associated with the first object, the first object currently not in focus (that is, the focus frame has been moved out of the area of the object) still may be identified (for example, highlighted) to be distinguished from the other objects to thereby indicate that the associated information displayed in the current associated information display area is associated with the first object, and the first object will not be identified until the focus is switched to another object (referred below to as a second object for the sake of description). That is to say, after the focus lands on one of the N objects, the object is identified until the focus lands on another object.

According to some embodiments, in the case where the focus is switched as described above, the object where the focus lands may or may not be displayed differently from after the focus does not land on the object (the focus lands on the associated information associated with the object instead of the other object). When the object is identified differently, for example, before the focus does not land on the object, the background of the area of the object is white (and the background of the areas of the objects where the focus does not land is green), and after the focus does not land on the object, the background of the area of the object is black (and the background of the areas of the objects where the focus does not land is green).

According to some embodiments, in some embodiments of this disclosure, after the focus lands on one of the N objects (e.g., dates in a calendar application), the background of the user interface may be displayed as a background corresponding to the object where the focus currently lands, in response. In a particular embodiment, backgrounds or a default background may be set for the different objects. For example, if the focus lands on June 21, the background of the user interface may be set to a picture related to the date which is a Chinese solar term “summer solstice” in the lunar calendar. The background of the user interface corresponding to an object may be set by the system, or may be set by the user. The embodiments of this description will not be limited thereto.

By way of example, FIG. 5 illustrates a schematic structural diagram of a user interface where dates and their associated information are displayed as described above. In the user interface, a date display area (i.e., a first area) 501 is arranged above an associated information display area (i.e., a second area) 502.

The dates are displayed in one row in the date display area 502, and a focus may be switched among the respective dates through the Left and Right direction buttons on the remote controllers. When the focus is switched to the last date in the user interface, if the Right direction button on the remote controller is pressed, the focus may be switched to the next date, and the calendar may slide leftward to display the dates after the current focused date. When the focus is switched to the first date in the user interface, if the Left direction button on the remote controller is pressed, the focus may be switched to the last date, and the calendar may be slid rightward to display the dates before the date where the focus currently lands.

The associated information display area 502 includes two upper and lower sub-areas, where the upper first sub-area includes a visible control 503, and the user may trigger the visible control 503 to create reminder information associated with a selected date. The reminder information, created by the user, associated with the currently selected date may be displayed in the first sub-area configured to display reminder information, and for example, in a reminder information area 5031 to a reminder information area 5034, where reminder information which is set in one setting operation may be displayed in each of the reminder information area 5031 to the reminder information area 5034. Optionally reminder information areas may be allowed to be slid rightward or leftward to thereby display other reminder information.

The second sub-area in the lower portion of the associated information display area includes one or more sub-areas. For example, there are three sub-areas as illustrated, which are a sub-area 5021, a sub-area 5022, and a sub-area 5023. Each sub-area may be configured to display a recommended item which is set by the system (e.g., information about a recommended movie set by the system). After a piece of associated information in the sub-area 5021 to the sub-area 5023 is triggered, a related operation may be performed on the corresponding recommended item in response.

By way of example, FIG. 6a illustrates a user interface 600 in the user interface structure as illustrated in FIG. 5. The user interface 600 may include a date display area 601 and an associated information display area 602 in substantially the same structure as that as illustrated in FIG. 5, where a calendar is displayed in the date display area 601, and dates in the calendar are displayed in one row.

As illustrated in FIG. 6a, a focus lands on Apr. 15, 2018 in the calendar currently displayed in the date display area 601, and the color of the background of the date different from the color of the background of the other dates not in focus, to thereby indicate that the date is a date where the focus lands. Since there is no reminder information associated with Apr. 15, 2018, no reminder information associated with the date, but only a visible control 6021 configured to create reminder information is displayed in a reminder information display sub-area located in the upper portion of the associated information display area 602. A recommended item display sub-area located in the lower portion of the associated information display area 602 includes five sub-areas (6022 to 6026) in each of which an application related picture is displayed, where each picture includes the name of the related application to indicate a recommended application associated with Apr. 15, 2018.

As illustrated in FIG. 6b, after the user presses the Down direction button on the remote controller, in the user interface as illustrated in FIG. 6a, the focus is switched to the visible control 6021 in the reminder information display sub-area located in the upper portion of the associated information display area 602, and also the background of display area of Apr. 15, 2018 is changed, but the changed background is still different from backgrounds of display areas of other dates to thereby indicate that the information currently displayed in the associated information display area 602 is associated with the date (Apr. 15, 2018).

As illustrated in FIG. 6c, after the user presses again the Down direction button on the remote controller, in the user interface as illustrated in FIG. 6b, the focus is switched to the first sub-area 6022 of recommended item display sub-areas located in the lower portion of the associated information display area 602, and also the background of the display area of Apr. 15, 2018 is maintained.

In another example, the user is provided with more options, that is, the user is allowed to decide to display the objects and their associated information as described in the embodiments of this description, or in a conventional display mode as he or she needs.

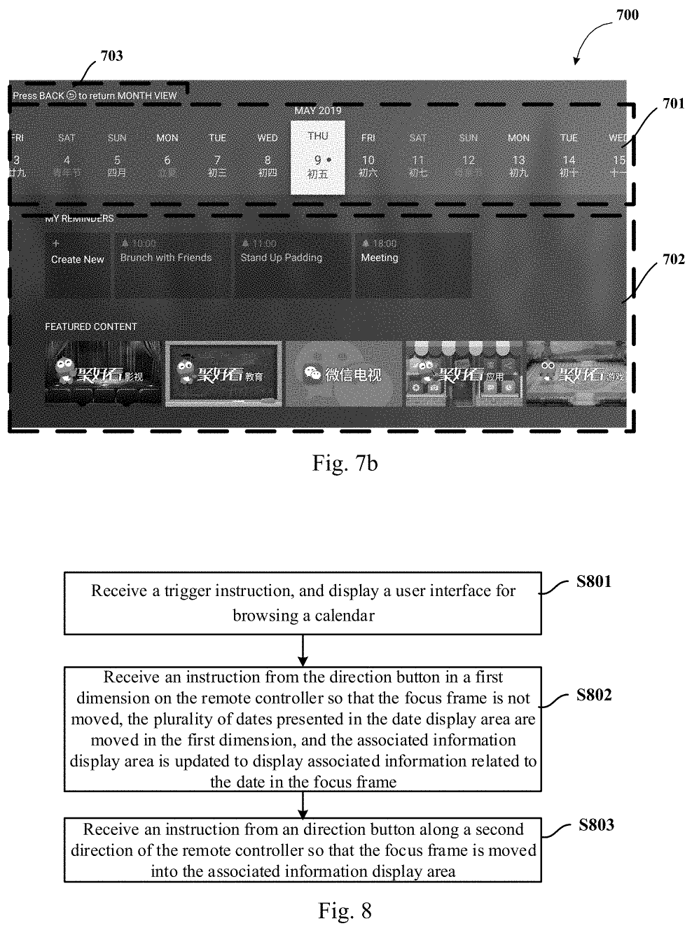

For example, the user interface may be switched between different display modes through a switching function button in the user interface. In a calendar application, for example, after the calendar application is entered, a calendar may be displayed in a legacy display mode by default in a user interface 700 as illustrated in FIG. 7a. In FIG. 7a, dates of a month are displayed in multiple rows and columns in a date display area 701. After a focus lands on Jul. 6, 2017 in the date display area 701, pictures of three movie programs associated with the date are displayed in an associated information display area 702, where the three movie programs are the movie Spiderman, the cartoon Emoji, and the movie Wonderwomen respectively.

The user interface 700 may include a Switch Display button 703. After the user presses the Switch Display button 703 in the user interface as illustrated in FIG. 7a, the user interface 700 may be as illustrated in FIG. 7b. In FIG. 7b, the dates in the date display area 701 are displayed in one row, the three movie programs associated with the selected date of May 9, 2019 are displayed in the associated information display area 702, and the Switch Display button 703 is also displayed in the user interface. If the user presses the Switch Display button 703 in the user interface, the user interface may be switched back to the user interface as illustrated in FIG. 7a.

In another example, after the focus lands on May 9, 2019 in the date display area 701 as illustrated in FIG. 7a, the user interface may be as illustrated in FIG. 7b after an OK button on the remote controller is pressed according to reminder information “Press OK to open day view” displayed in the reminder information display area. In FIG. 7b, newly created reminder information “May 9, 2019” is set.

Of course, after the calendar application is entered, the user interface as illustrated in FIG. 7b may alternatively be displayed by default, and if the user presses the Display Switching button 703, the user interface may be switched to that as illustrated in FIG. 7a.

Following the description above, the method for displaying a user interface for presenting a calendar according to the embodiments of this description will be described below in details with reference to FIG. 8.

FIG. 8 illustrates a schematic flow chart of a method for displaying a user interface for presenting a calendar according to an embodiment of this disclosure. The flow may be performed by a terminal, or may be performed by a device for processing a user interface in the terminal, where the type of the terminal may be as described in the embodiments above.

In the embodiments of this description, an application including the user interface above may be a system application, or may be a third-party application. For example, the application is a system application in a smart TV set, and the application may be a calendar application to provide functions of viewing a calendar and its related information. The following flow will be described by way of a scenario example where firstly the calendar application is started, and the user interface of the calendar application is opened; then a date in the date display area is selected through the remote controller; and next associated information in the associated information display area is selected through the remote controller.

As illustrated, the flow may include the following steps:

The step S801 is to receive a trigger instruction, and to display a user interface for browsing a calendar.

In an example, after the smart TV set is started, firstly a home page of the smart TV set may be displayed, where an entry to a calendar application is displayed on the home page, for example, an icon of the calendar application is displayed at the top right corner of the home page, and after the user lands a focus on the icon through the remote controller of the smart TV set, and presses the “OK” button, the calendar application may be started, and the user interface of the application may be displayed.

In particular, information displayed in the user interface, and the structure of the user interface may be similar to the embodiments described above. Briefly the user interface includes a date display area for displaying a plurality of dates arranged in one row or in one column, and an associated information display area for displaying associated information related to one of the dates. For example, the user interface may be as illustrated in FIG. 6a.

After the calendar application is started, and the user interface for browsing a calendar is displayed, a focus frame may be located in the date display area by default, and a specific date, e.g., the current date, may be located in the focus frame by default.

The step S802 is to receive an instruction from the direction button in a first dimension on the remote controller so that the focus frame is not moved, the plurality of dates presented in the date display area are moved in the first dimension, and the associated information display area is updated to display associated information related to the date in the focus frame.

Particularly if the dates in the date display area are displayed in one row, the first dimension is the horizontal direction; and if the dates in the date display area are displayed in one column, the first dimension is the vertical direction.

In this step, the user may move a date out of the focus frame and another date into the focus frame through the remote controller (while the position of the focus frame is maintained) to thereby switch the focus among the different dates.

For example, the dates in the date display area are displayed in one row, and after the user presses the Right direction button on the remote controller, the terminal may receive a instruction from the remote controller, so the current position of the focus frame is maintained in response, and all the dates in the date display area are moved leftward respectively by one place in the horizontal direction, so that the focus lands on the second date right-adjacent to the first date instead of the first date. Thereafter after the user presses the Left direction button on the remote controller, the terminal may receive instruction from the remote controller, so the current position of the focus frame is maintained in response, and all the dates in the date display area are moved rightward respectively by one place in the horizontal direction, so that the focus lands on the first date left-adjacent to the second date instead of the second date.

In the process above, when the user updates the date in the focus frame through a direction button on the remote controller, the terminal may receive a signal sent by the remote controller, and the operating system of the terminal may generate a corresponding user operation event according to the received signal, and send the user operation event to the device for displaying a user interface in the terminal, so that the device switches the focus among the different dates in response to the user operation event.

In this step, associated information associated with the date in the current focus frame is displayed in the associated information display area of the user interface according to the date in the focus frame.

In the embodiments of this description, there may be other associated information associated with a date. Information associated with a date includes associated information set by the system, or associated information set by the user.

According to some embodiments, the date, and the associated information associated with the date may be stored in the terminal in a database or another data structure, for example, may be stored as Key-Value pairs. In a calendar application, for example, a Key-Value pair includes Key which is the value of a date, and Value which is the associated information associated with the date. There may be a plurality of pieces of associated information which may be separated by separators.

The step S803 is to receive an instruction from an direction button along a second direction of the remote controller so that the focus frame is moved into the associated information display area.

Particularly if the first dimension is the horizontal direction, the second dimension is the vertical direction; and if the first dimension is the vertical direction, the second dimension is the horizontal direction.

For example, if the associated information display area is located below the date display area in the user interface, the second dimension will be the vertical direction. In this step, when the focus frame is located in the date display area, if the user presses a direction button for downward movement along the vertical direction on the remote controller, the terminal receives the instruction for downward movement along the vertical direction, which is sent by the remote controller, and then move the focus frame into the associated information display area in response.

For example, if the associated information display area is located below the date display area in the user interface, the second direction is the vertical direction. When the focus frame is located in the associated information display area, if the user presses a direction button for upward movement along the vertical direction on the remote controller, the terminal receives the instruction for upward movement along the vertical direction, which is sent by the remote controller, and then move the focus frame into the date display area in response.

In the flow as illustrated in FIG. 8, if there is no associated information associated with the currently selected date, no corresponding associated information will be displayed in the associated information display area of the user interface. According to some embodiments, a visible control for setting associated information may be displayed in the associated information display area so that the user may set associated information for the currently selected date.

According to some embodiments, in the flow as illustrated in FIG. 8, the date in the focus frame may be identified, for example, highlighted. The date may be highlighted as described in the embodiments above.

According to some embodiments, in the flow as illustrated in FIG. 8, after the date in the focus frame is updated, the flow above may further include the step of updating the background of the user interface with a background corresponding to the date in the current focus frame. A background corresponding to a date may be a background which is set by the user for the date, or may be a background which is set by the system for the date, or may be a background defaulted by the system.

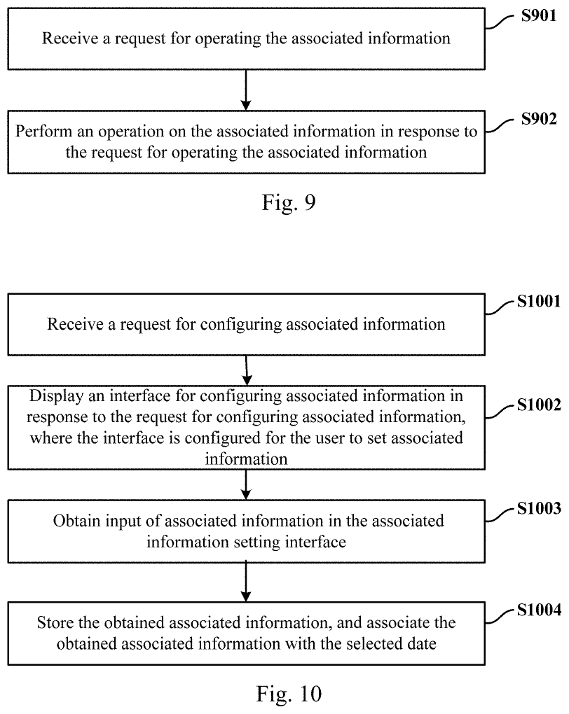

According to some embodiments, at least one piece of associated information is displayed as a visible control in the associated information display area. After the step S803 in the flow as illustrated in FIG. 8, that is, after the focus frame is moved to a visible control corresponding to a piece of associated information in the associated information display area, as illustrated in FIG. 9, the flow may further include the following steps.

The step S901 is to receive a request for operating the associated information.

In this step, the request may be sent by pressing a button for confirm on the remote controller, where the request is generated when the visible control is triggered. In some examples, after the user moves a date into the focus frame through the remote controller, and moves the focus frame to associated information presented in the associated information display area through the remote controller, he or she may further send the request for operating associated information to the terminal through a function button (e.g., the button for confirm) on the remote controller to request for an operation on the associated information.

The step S902 is to perform an operation on the associated information in response to the request for operating the associated information.

In this step, there may be a different operation which may be performed on different associated information. By way of example, at least one piece of associated information among the information associated with the date where the focus currently lands is displayed as a visible control associated with a video resource, so that performing the operation on the associated information may include but not limited to: playing the video associated with the visible control, or displaying a page of details about the video. Particularly a video player may be started, and the video associated with the visible control may be played. In another example, if the visible control is associated with an application, performing the operation on the associated information may include: starting the application associated with the visible control.

According to some embodiments, the associated information display area may further include a visible control for configuring associated information. Correspondingly after the step S803 in the flow as illustrated in FIG. 8, that is, after the focus frame is moved to the visible control for configuring associated information in the associated information display area, as illustrated in FIG. 10, the flow may further include the following steps.

The step S1001 is to receive a request for configuring associated information.

In this step, the request may be sent by pressing a button for confirm on the remote controller, where the request for configuring associated information is generated when the visible control is triggered. In some examples, after the user moves a date into the focus frame through the remote controller, and moves the focus frame to the visible control for setting associated information in the associated information display area, through the remote controller, the user may further send the request for configuring the associated information through a function button (e.g., the button for confirm) on the remote controller to request for setting associated information associated with the selected object.

The step S1002 is to display an interface for configuring associated information in response to the request for configuring associated information, where the interface is configured for the user to set associated information.

Particularly the terminal may receive associated information input by the user in the associated information setting interface.

The step S1003 is to obtain input of associated information in the associated information setting interface.

The step S1004 is to store the obtained associated information, and to associate the obtained associated information with the selected date.

According to some embodiments, the date, and the associated information associated with the date may be stored in the terminal in a database or another data structure, for example, as key-value pairs.

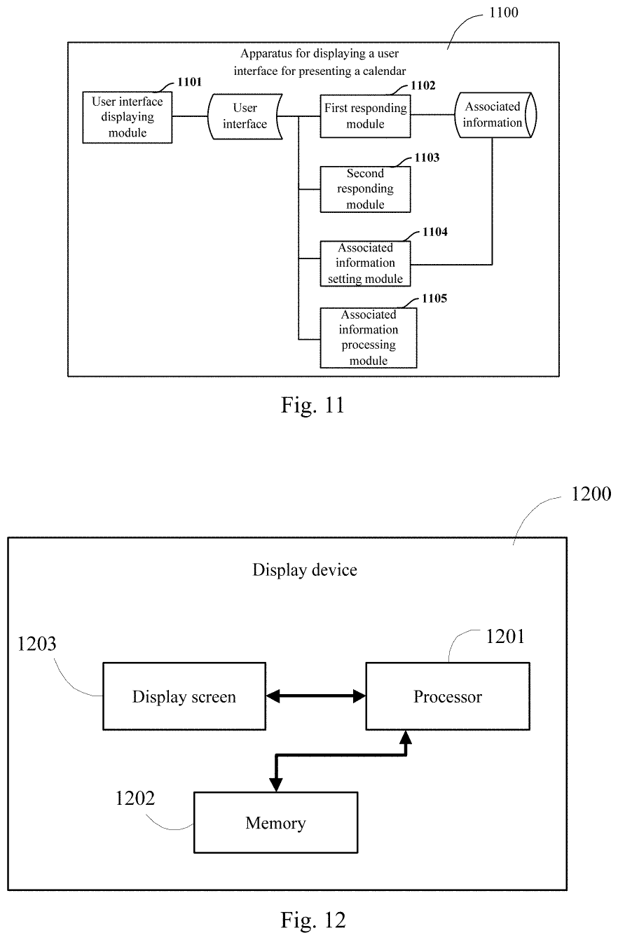

FIG. 11 illustrates a schematic structural diagram of an apparatus for displaying a user interface for presenting a calendar according to an embodiment of this disclosure, where the apparatus includes integrated units (or elements). As illustrated in FIG. 11, the apparatus 1100 includes a user interface displaying module 1101, a first responding module 1102, and a second responding module 1103. According to some embodiments, the apparatus 1100 may further include one or more of an associated information setting module 1104 and an associated information processing module 1105.

The user interface displaying module 1101 is configured to receive a trigger instruction, and to display a user interface for browsing a calendar, where the user interface includes a date display area for displaying a plurality of dates arranged in one row or in one column, and an associated information display area for displaying associated information related to one of the dates.

The first responding module 1102 is configured to receive an instruction from the direction button in a first dimension of a remote controller, to maintain a focus frame in position, to move the plurality of dates in the date display area in the first dimension, and to update the associated information display area to display associated information associated with data in the focus frame.

The second responding module 1103 is configured to receive an instruction from a direction button in a second dimension of the remote controller, and to move the focus frame between the date display area and the associated information display area.

According to some embodiments, the first responding module 1102 may be configured: to receive an instruction for movement in a first dimension from a direction button along the first dimension sent by the remote controller, to maintain the current position of the focus frame in response, and to move all the dates in the date display area respectively by one place in a second direction so that a focus does not land on a first date, but lands on a second date adjacent to the first date in the first dimension, where the first dimension is opposite to the second direction.

According to some embodiments, the second responding module 1103 may be configured: when the focus is located in the date display area, to receive an instruction for movement in a third direction from a direction button along the second dimension sent by the remote controller, and to move the focus frame into the associated information display area, where the date display area and the associated information display area are arranged in the third direction in order; or when the focus frame is located in the associated information display area, to receive an instruction for movement in a fourth direction from a direction button along the second dimension, sent by the remote controller, and to move the focus frame into the date display area, where the third direction is opposite to the fourth direction.

According to some embodiments, the first responding module 1102 is further configured to change the background of the user interface to a background corresponding to the date in the focus frame upon reception of the instruction from the direction button along the first dimension from the remote controller.

According to some embodiments, the associated information display area further includes a visible control for setting associated information. The associated information setting module 1104 may be configured, after the focus is moved to the visible control for setting associated information in the associated information display area, to receive an instruction from a button for confirm of the remote controller, and to cause the visible control to provide a setting interface for setting associated information associated with a selected data which is a date in the focus frame before the focus frame is moved into the associated information display area.

According to some embodiments, at least one piece of associated information is displayed as a visible control in the associated information display area. The associated information processing module 1105 may be configured, after the focus frame is moved to the visible control corresponding to the associated information in the associated information display area, to receive a confirmation instruction from a button of the remote controller, and to display a page of details about an item associated with the visible control, or to play an item associated with the visible control, or to start an application associated with the visible control.

According to some embodiments, after the focus is moved out of the date display area, the date in the focus frame before it was moved out of the date display area is identified.

According to some embodiments, the first dimension and the second dimension are one and the other of the horizontal direction and the vertical direction respectively.

FIG. 12 illustrates a schematic structural diagram of a display device according to an embodiment of this disclosure, i.e., another schematic structural diagram of the apparatus 1100. As illustrated in FIG. 12, the display device 1200 includes a processor 1201 and a memory 1202, and may further include a display screen 1203, where the processor 1201 may alternatively be a controller. The processor 1201 is configured to enable the display device 1200 to perform the functions in any one of the flows as illustrated in FIG. 8 to FIG. 10. The memory 1202 is coupled with the processor 1201, and configured to store program instructions and data associated with the display device 1200. The processor 1201, the memory 1202, and the display screen 1203 are connected with each other, the memory 1202 is configured to store instruction, and the processor 1201 is configured to execute the instructions stored in the memory 1202 to perform the steps in the corresponding functions performed by the display device 1200 in the method above.

In the embodiments of this description, reference may be made to the descriptions in the method above or the other embodiments for the concepts, explanations, and details as well the other steps, in the apparatus 1100 and the display device 1200, which accord with the solutions according to the embodiments of this disclosure.

It shall be noted that the processor as referred above to in the embodiments of this disclosure may be a Central Processing Unit (CPU), a general-purpose processor, a Digital Signal Processor (DSP), an Application-Specific Integrated Circuit (ASIC), a Field Programmable Gate Array (FPGA), or another programmable logic device, transistor logic device, hardware component, or any combination thereof. It may be embodied as or operate as various exemplary logic blocks, modules, and circuits described according to this disclosure. The processor may alternatively be embodied as a combination of computing functions, e.g., a combination of one or more micro-processors, a combination of a DSP and a micro-processor, etc. The memory may be integrated in the processor, or may be arranged separate from the processor.

Some embodiments of this disclosure further provide a computer readable storage medium configured to storage some instructions, where the instructions may perform the method in the display device above upon being executed.

Some embodiments of this disclosure further provide a computer program product configured to store computer program configured to perform the method according to the embodiment above of this disclosure.

Some embodiments of this disclosure further provide a chip including a processor configured to enable a display device to perform the functions in the display device above. In a possible design, the chip further includes memory configured to storage program instructions and data necessary to the display device.

Those skilled in the art shall appreciate that the embodiments of this disclosure may be embodied as a method, a system or a computer program product. Therefore the invention may be embodied in the form of an all-hardware embodiment, an all-software embodiment or an embodiment of software and hardware in combination. Furthermore the invention may be embodied in the form of a computer program product embodied in one or more computer useable storage mediums (including but not limited to a disk memory, a CD-ROM, an optical memory, etc.) in which computer useable program codes are contained.

The application has been described in a flow chart and/or a block diagram of the method, the device (system) and the computer program product according to the embodiments of this disclosure. It shall be appreciated that respective flows and/or blocks in the flow chart and/or the block diagram and combinations of the flows and/or the blocks in the flow chart and/or the block diagram may be embodied in computer program instructions. These computer program instructions may be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions may also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions may also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

What is claimed is:

1. A method for displaying a user interface for presenting a calendar, the method comprising:
displaying the user interface for presenting the calendar in response to a trigger instruction, wherein a plurality of dates arranged in line are presented in a first area of the user interface, and associated information associated with one of the plurality of dates is presented in a second area of the user interface; and
in response to a first date among the plurality of dates being selected through a remote controller, presenting associated information associated with the first date in the second area.

2. The method according to claim 1, wherein the plurality of dates presented in the first area of the user interface are arranged in line in a first dimension; and
the method further comprises: in response to receiving a signal which is sent by a press operation on a direction button along a first preset direction on the remote controller, moving a focus frame from the first area where the first date is located to the second area in a second dimension; and
wherein the first preset direction is along the second dimension, and the second dimension is different from the first dimension.

3. The method according to claim 2, further comprising:
in response to receiving a signal which is sent by a press operation on a direction button along a second preset direction on the remote controller, selecting a second date among the plurality of dates, wherein the second preset direction is along the first dimension; and
updating the second area to present associated information associated with the second date.

4. The method according to claim 1, wherein the second area comprises a first sub-area and a second sub-area, wherein local information associated with the first date is presented in the first sub-area, and at least one recommended item associated with the first date is presented in the second sub-area.

5. The method according to claim 4, wherein the first sub-area further comprises at least one first visible control for setting the local information.

6. The method according to claim 5, further comprising:
in response to an operation on a first visible control, presenting a setting interface for setting the local information;
receiving information inputted in the setting interface; and
associating the received information with the first date, and storing the received information.

7. The method according to claim 4, wherein the second sub-area comprises at least one second visible control for presenting the at least one recommended item respectively.

8. The method according to claim 7, further comprising:
in response to an operation on a second visible control, presenting details about a recommended item corresponding to the second visible control, or playing video content of a recommended item corresponding to the second visible control, or starting an application program of a recommended item corresponding to the second visible control.

9. The method according to claim 1, further comprising:
in response to the first date among the plurality of dates being selected by the remote controller, presenting an image corresponding to the first date as a background of the user interface.

10. A display device, comprising:
a display screen,
a memory, configured to store computer instructions and data associated with the display screen; and
a processor in connection with the display screen and the memory, and configured to execute the computer instructions to cause the display device to:
display a user interface for presenting a calendar on the display screen, in response to a trigger instruction, wherein a plurality of dates arranged in line are presented in a first area of the user interface, and associated information associated with one of the plurality of dates is presented in a second area of the user interface; and
in response to a first date among the plurality of dates being selected through a remote controller, present associated information associated with the first date in the second area.

11. The display device according to claim 10, wherein the processor is further configured to execute the computer instructions to cause the display device to:
present the plurality of dates in line in a first dimension, in the first area of the user interface; and
the processor is further configured to execute the computer instructions to cause the display device to:
in response to receiving a signal which is sent by a press operation on a direction button along a first preset direction on the remote controller, move a focus frame from the first area where the first date is located to the second area in a second dimension, wherein the first preset direction is along the second dimension, and the second dimension is different from the first dimension.

12. The display device according to claim 11, wherein the processor is further configured to execute the computer instructions to cause the display device to:
in response to receiving a signal which is sent by a press operation on a direction button along a second preset direction on the remote controller, select a second date among the plurality of dates, wherein the second preset direction is along the first dimension; and
update the second area to present associated information associated with the second date.

13. The display device according to claim 10, wherein the second area comprises a first sub-area and a second sub-area, wherein local information associated with the first date is presented in the first sub-area, and at least one recommended item associated with the first date is presented in the second sub-area.

14. The display device according to claim 13, wherein the processor is further configured to execute the computer instructions to cause the display device to:
present at least one first visible control for setting the local information in the first sub-area.

15. The display device according to claim 14, wherein the processor is further configured to execute the computer instructions to cause the display device to:
in response to an operation on a first visible control, present a setting interface for setting the local information;
receive information inputted in the setting interface; and
associate the received information with the first date, and storing the received information.

16. The display device according to claim 13, wherein the processor is further configured to execute the computer instructions to cause the display device to:
present at least one second visible control for presenting the at least one recommended item respectively in the second sub-area.

17. The display device according to claim 16, wherein the processor is further configured to execute the computer instructions to cause the display device to:
in response to an operation on a second visible control, present details about a recommended item corresponding to the second visible control, play video content of a recommended item corresponding to the second visible control, or start an application program of a recommended item corresponding to the second visible control.

18. The display device according to claim 10, wherein the processor is further configured to execute the computer instructions to cause the display device to:
in response to the first date among the plurality of dates being selected by the remote controller, present an image corresponding to the first date as a background of the user interface.

19. A non-transitory machine-readable storage medium configured to store instructions that, when executed by processing circuitry, cause the processing circuitry to:
receive a trigger instruction;
display a user interface for presenting a calendar on a display screen in response to the trigger instruction, wherein a plurality of dates arranged in line are presented in a first area of the user interface, and associated information associated with one of the plurality of dates is presented in a second area of the user interface;
receive a selection signal from a remote controller; and
in response to a first date among the plurality of dates being selected is included in the selection signal, present associated information associated with the first date in the second area.

20. The non-transitory machine-readable storage medium according to claim 19, configured to store instructions, when executed by processing circuitry, further cause the processing circuitry to:
present the plurality of dates in line in a first dimension, in the first area of the user interface; and
in response to receiving a second selection signal which is sent by a press operation on a direction button along a first preset direction on the remote controller, move a focus frame from the first area where the first date is located to the second area in a second dimension, wherein the first preset direction is along the second dimension, and the second dimension is different from the first dimension.
